(19) United States
(12) Patent Application Publication
(10) Pub. No.: US 2023/0396084 A1
(43) Pub. Date: Dec. 7, 2023

(54) CHARGING APPARATUS FOR PORTABLE ELECTRONIC DEVICES

(71) Applicants: Tanner Wills, Huntington Beach, CA (US); Tyler Johnson, Los Angeles, CA (US)

(72) Inventors: Tanner Wills, Huntington Beach, CA (US); Tyler Johnson, Los Angeles, CA (US)

(21) Appl. No.: 18/328,972

(22) Filed: Jun. 5, 2023

Related U.S. Application Data
(60) Provisional application No. 63/349,155, filed on Jun. 6, 2022.

(51) Int. Cl. H02J 7/00; H02J 50/00; A45F 5/00

(52) U.S. Cl. CPC H02J 7/0044; H02J 50/005; A45F 5/00; A41D 1/002

(57) ABSTRACT

An apparatus and method for charging a portable electronic device, such as a smartphone. The apparatus includes a bag that has a phone pocket to receive the portable electronic device. The bag further has a charging device pocket to receive a charging device. The charging device has wireless charging circuitry for charging the portable electronic device within the phone pocket.

### CROSS-REFERENCE TO RELATED APPLICATIONS

This application claims priority from a U.S. Provisional Patent Application Ser. No. 63/349,155, filed on Jun. 6, 2022, the disclosure of which is incorporated herein by reference in their entirety.

### FIELD OF INVENTION

The present invention relates to an apparatus for charging a portable electronic device, and more particularly, the present invention relates to a bag with charging functionality.

### BACKGROUND

Portable electronic devices have made many tasks in day-to-day life easier and more convenient. Smartphones have become an indispensable part of life and people generally carry their smartphones with them wherever they go. Revolutionary developments in battery technology have allowed portable electronic devices to work for several hours. Most of the research and development in battery technologies, nowadays, is mainly focused on decreasing the weight of batteries and increasing the power back. However, portable electronic devices have to be charged frequently depending upon the usage. Smartphones are equipped with a variety of features useful in daily life that results in excessive use and dependency on the smartphone, which requires more frequent charging for battery.

Power banks are available for charging portable electronic devices. Power banks are like additional batteries but can charge other devices through an inbuilt charging interface, which can be wired or wireless. Although portable power banks are handy when needed, connecting the portable electronic device to the power bank can often become inconvenient and messy. For example, the cable to connect the power bank to the phone for charging can tangle creating a mess.

A need is therefore appreciated for an improved apparatus for charging portable electronic devices that overcomes the drawbacks or limitations of charging the devices with the power bank.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus that can be worn by a user while wirelessly charging the portable electronic device.

It is another object of the present invention is that the apparatus can be used to carry utility articles.

It is still another object of the present invention that the apparatus can be carried like a handbag.

It is yet another object of the present invention that the apparatus can be worn like a sling bag.

It is a further object of the present invention that the apparatus provides an optimum charging environment.

It is still a further object of the present invention that the apparatus allows charging the portable electronic device safely.

It is an additional object of the present invention that the apparatus allows the charging of different size smartphones efficiently.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of an apparatus, according to an exemplary embodiment of the present invention.

FIG. 2 is a front view of the apparatus, according to an exemplary embodiment of the present invention.

FIG. 3 is a rear view of the apparatus, according to an exemplary embodiment of the present invention.

FIG. 4 shows a front pocket, also referred to herein as a phone pocket, in the bag, according to an exemplary embodiment of the present invention.

FIG. 5 shows an exploded view of a bag of the apparatus, according to an exemplary embodiment of the present invention.

FIG. 6 is a schematic drawing showing a battery pocket in the bag, according to an exemplary embodiment of the present invention.

FIG. 7 is another view showing arrangements of layers in the bag relative to the battery pocket, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is an apparatus for charging portable electronic devices, such as smartphones, tablet computers, smartwatches, and the like consumer portable electronics. Preferably, the disclosed apparatus can be used to charge smartphones. The invention is advantageous in that it may allow for the proper aligning of smartphones of varying sizes in a pocket of a bag of the disclosed apparatus for wireless charging. The disclosed apparatus allows for the wireless charging of smartphones in an optimum environment. For wireless charging, alignment or positioning of the smartphone relative to a wireless charger is critical, and so the disclosed apparatus allows for smartphones of different sizes to optimally align with a wireless charger of the disclosed apparatus. The disclosed apparatus includes a bag and a wireless charger.

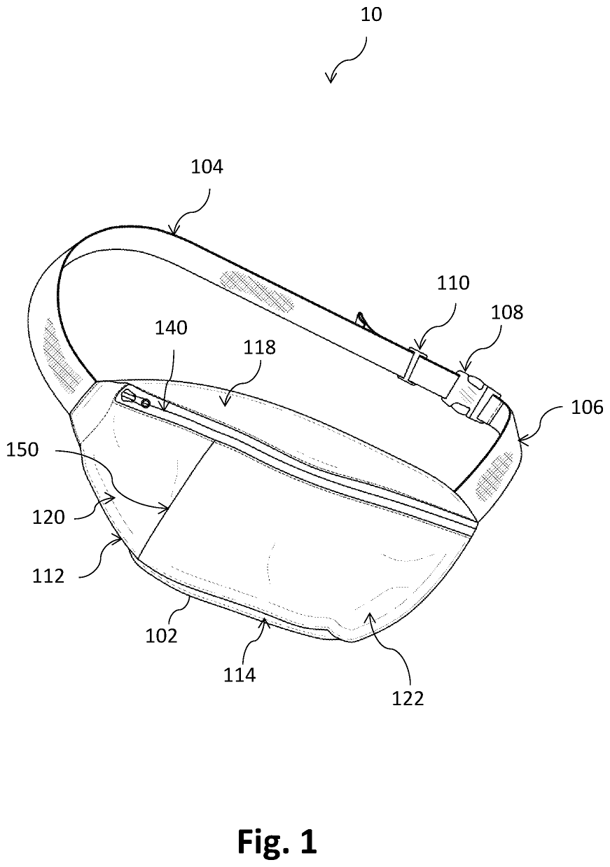

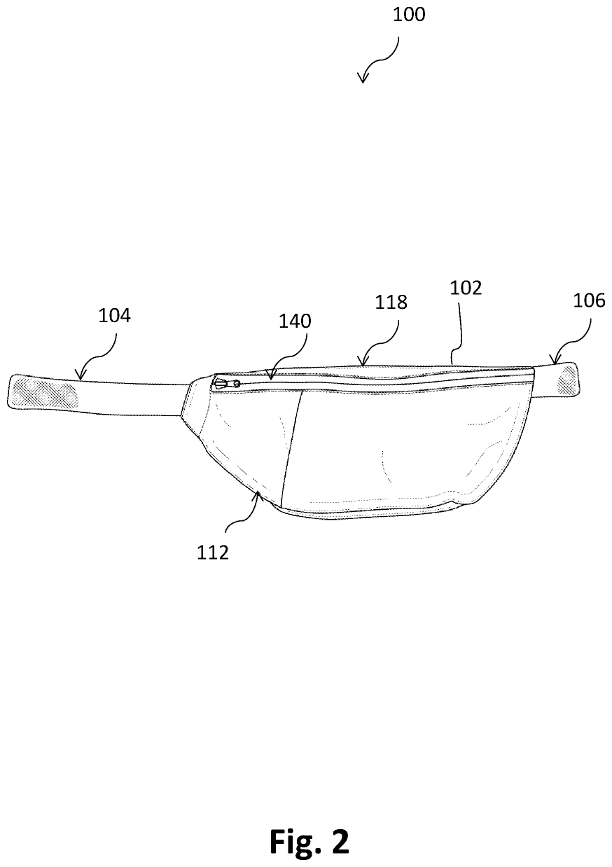

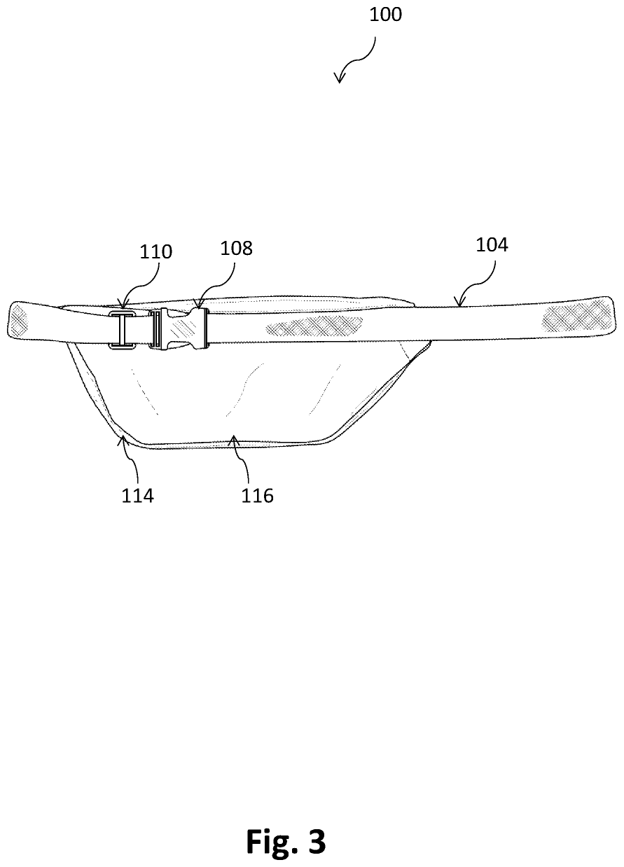

Referring to FIGS. 1-3 which show different views of apparatus 100 includes a bag and a charging device encased within the bag. The bag includes a bag body 102 of a sling bag type having an elongated profile with a proximal end and a distal end. A first strap 104 extends from the proximal end and a second strap 106 extends from the distal end of the bag body 102. The free ends of the two straps can have a suitable fastener 108 for coupling the two ends. Examples of the fastener include push-release buckles or brackets. As shown in the drawing, the first strap is longer than the second strap. A length adjustment buckle 110 is also provided in the first strap. The buckle is shown as an example, and any length-adjusting member is within the scope of the present invention. The buckle 110 can also be provided in the second strap or both straps.

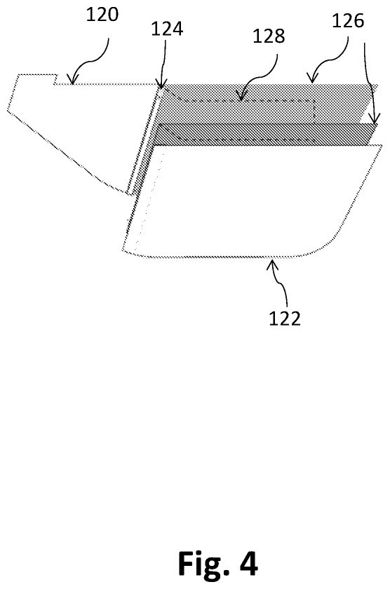

The bag body 102 has a front panel 112, a bottom panel 114, a rear panel 116, and a top panel 118. The front panel is divided into two portions i.e., a left portion 120 and a right portion 122. The right portion is longer than the left portion. The left portion is adjacent to the proximal end and the right portion is adjacent to the distal end of the bag body. A right edge of the left portion and a left edge of the right portion are adjacent to each other. The left edge of the right portion is not bonded or stitched, providing access to a phone pocket. The right edge of the left portion and the left edge of the right portion forms an opening for the phone pocket. The opening has a zipper 124 to open and close the phone pocket. The left edge of the right portion is not bonded but extended to form a hem lining 150 that can hide or overlap the zipper. The hem lining can be pulled outwards to gain access to the zipper and into the phone pocket. The phone pocket is behind the right portion of the front panel. The phone pocket is formed by two liners 126, in which the edges of the two liners and the left portion of the front panel can be stitched to the zipper. FIG. 4 shows the left portion and the right portion of the front panel and the two liners. The two liners can be stitched along the broken line 128, such that the pattern of stitching as shown in the drawing is a critical feature of the invention and helps to keep the phone aligned relative to the charger of the apparatus.

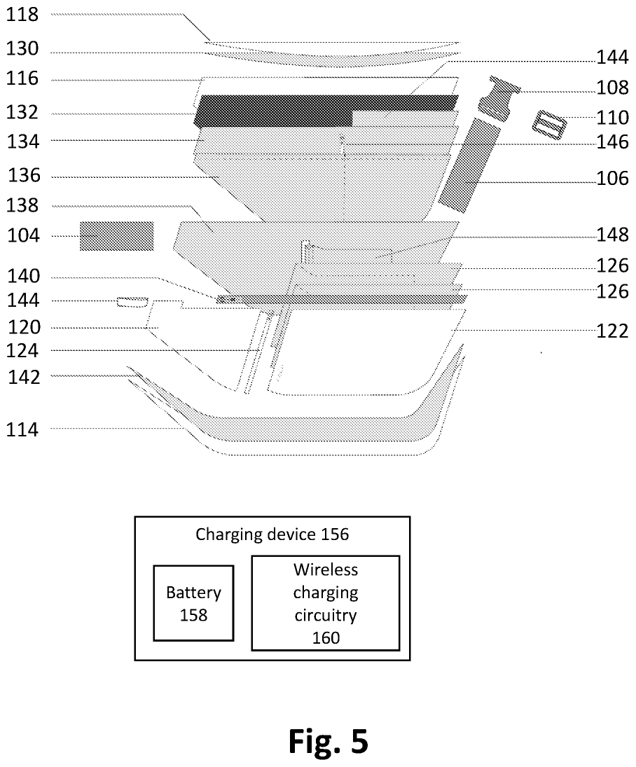

FIG. 5 shows an exploded view of the bag that includes a left portion 120 and right portion 122 of the front panel, a bottom panel 114, a rear panel 116, a top panel 118, a top liner 130, a rear insulative layer 132, a rear liner 134, a divider panel 136, a front liner 138, a top longitudinal zipper 140, a traversing front panel zipper 134, a bottom liner 142, a key pocket liner 144, a key pocket zipper 146, a battery pocket liner 148, a pair of phone pocket liners 126, a left strap 104, a right strap 106, a release buckle 108, tension −D ring 110, and a lock loop 144.

In certain implementations, the panels including the front, rear, top, and bottom can be made from vinyl-backed Nylon. The outer panels can have suitable color and/or design for aesthetic purposes. The exposed surfaces of the panels can be made to withstand general wear and tear due to rubbing against external surfaces. The liners can be made from nylon, such as Taffeta Nylon. The insulation layer can be made from neoprene. The straps can be made from Nylon webbing. The zippers can be coated and made water-resistant. It is to be noted that the above materials are exemplary, and any suitable material can be used without departing from the scope of the present invention. Moreover, the outer surface of the outer panels can have a variety of functional layers, and any such addition or modification is within the scope of the present invention.

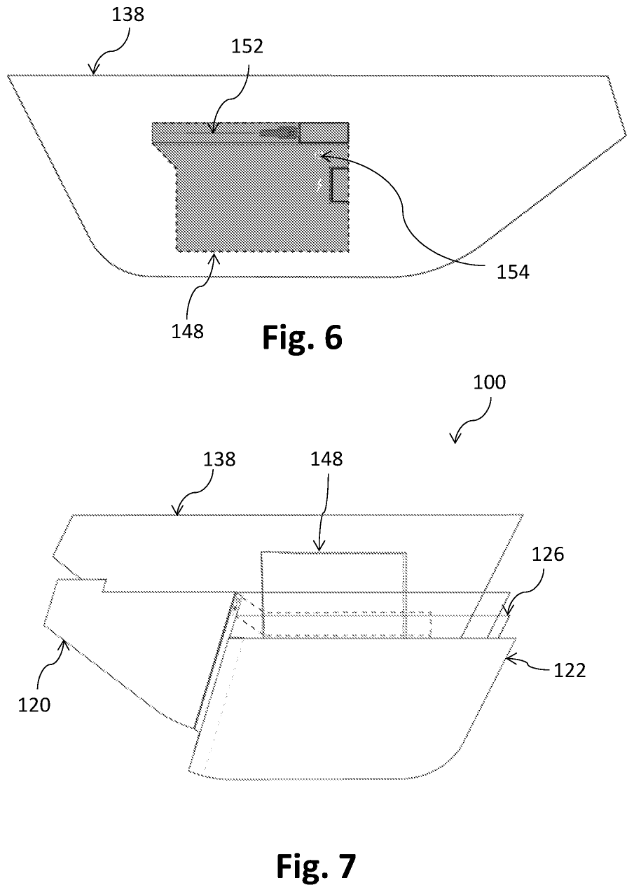

FIGS. 5 and 6 show the arrangement of the charging device pocket 148 of the disclosed apparatus 10. The pocket can be formed on liner 138 of the front panel. The liner, referred to as the front liner, lies on the inner side of the front panel. The pocket can be made on the rear side of the front liner, such that it can be accessible from the top/main zipper 140 in a compartment formed by the front liner and the dividing panel. The charger pocket is offset towards the right and behind the phone pocket. This allows the charger to be spatially positioned relative to a phone in the phone pocket for optimum alignment needed for charging the phone. The charging device 156 can include one or more battery units 158 and wireless charging circuitry 160, all encased within a housing. The charger pocket can be of such size to receive the charging device. However, a bigger size pocket i.e., a longer charger pocket is within the scope of the present invention. A large size charger pocket can be useful to accommodate a charging device of a larger size, such as of a higher capacity, making the disclosed invention more versatile and useful. Also, the user can adjust the position of the charging device relative to the different size phones in the phone pocket. Thus, a user can fix the position of the charging device according to their phone size, making the charging more efficient. To fix the charging device within the charger pocket, the empty space can be filled with suitable fillers, such as filler pads or foams can be used. Also, the walls of the charging device can be provided with a hook and loop fastener, continuous or spaced apart, such that empty space within the charger pocket can be closed by compressing the walls together. Fasteners other than hook and loop fasteners are within the scope of the present invention.

The charging pocket can have an opening for inserting and removing the charging device. The opening can be secured by a zipper 152, wherein the zipper can run longitudinally or transversely. The pocket has cutouts for indicator lights, such as a charging indicator of the charging device. A button 154 can be provided which can be actuated from outside the pocket to start charging. Instead of the button or in addition to the button, any sensing mechanism that can detect the presence of a phone in the phone pocket can also be used. Input from such a sensor can be used to turn on and off the charging device. For example, Mag chargers use magnets to detect the presence of a phone for charging. This may allow for automated charging of the phone whenever the phone is put into the phone pocket.

In use, a user can insert their phone into the phone pocket by opening the front traversing zipper. The zipper can be closed to keep the phone safe inside the front phone pocket. The phone can slide longitudinally into the phone pocket. Thereafter, the user can open the top or main zipper and then turn on the charging device by pressing the button of the charging device. The pressing of the button may be optional in the case of automated detection of the phone in the phone pocket. Also, the traversing zipper of the phone pocket can be replaced by any other fastening mechanism, such as a hook and loop fastener, snap buttons, and the like, and any such mechanism is within the scope of the present invention.

The bag can have two compartments formed by a divider panel. The two compartments can be used to store various utility articles, such as pens, bottles, and the like. On the rear compartment, a key pocket may also be provided. Between the rear liner and the rear panel, an insulative layer can be provided. The key pocket can be formed between a key pocket liner positioned adjacent to the insulation liner and the rear liner. A traversing cut in the rear liner can form an opening for the key pocket which can be secured by a zipper.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for charging a portable electronic device, the apparatus comprises:
a bag comprising:
a bag body, the bag body has a front panel, a rear panel, a top panel, and a bottom panel, the front panel is divided into a left portion and a right portion;
a phone pocket behind the right portion, the phone pocket is configured to receive the portable electronic device; and
a charging device pocket configured to receive a charging device, the charging device pocket is spatially positioned relative to the phone pocket, wherein the charging device pocket is encased within the bag body behind the phone pocket.

2. The apparatus of claim 1, wherein the phone pocket is made from two liners, wherein edges of the two liners and the left panel are stitched together to form the phone pocket, the phone pocket has an opening for receiving the portable electronic device.

3. The apparatus of claim 1, wherein the portable electronic device is a mobile phone.

4. The apparatus of claim 1, wherein the bag further comprises:
a first strap and a second strap; and
a releasable fastener coupling free ends of the first strap and the second strap.

5. The apparatus of claim 4, wherein the bag further comprises:
a length adjustment member configured to increase or decrease a length of the first strap or the second strap.

6. The apparatus according to claim 1, wherein the apparatus further comprises:
the charging device comprising one or more batteries and wireless charging circuitry.

7. The apparatus according to claim 2, wherein the opening of the phone pocket is closed by a zipper, the zipper extends transversely.

8. The apparatus according to claim 1, wherein the bag body has a main compartment, the main compartment is divided into two by a dividing panel, and the main compartment has a longitudinal opening at top of the bag body secured by a main fastener.

9. A method for charging a portable electronic device, the method comprising:
providing an apparatus comprising:
a bag comprising:
a bag body, the bag body has a front panel, a rear panel, a top panel, and a bottom panel, the front panel is divided into a left portion and a right portion,
a phone pocket behind the right portion, the phone pocket is configured to receive the portable electronic device, and
a charging device pocket configured to receive a charging device, the charging device pocket is spatially positioned relative to the phone pocket, wherein the charging device pocket is encased within the bag body behind the phone pocket;
receiving the charging device into the charging device pocket;
receiving the portable electronic device into the phone pocket; and
charging of the portable electronic device by the charging device.

10. The method of claim 9, wherein the phone pocket is made from two liners, edges of the two liners and of the left panel are stitched together to form the phone pocket, and the phone pocket has an opening for the portable electronic device.

11. The method of claim 9, wherein the portable electronic device is a mobile phone.

12. The method of claim 9, wherein the bag further comprises:
a first strap and a second strap; and
a releasable fastener coupling free ends of the first strap and the second strap.

13. The method of claim 12, wherein the bag further comprises:
a length adjustment member configured to increase or decrease a length of the first strap or the second strap.

14. The method of claim 9, wherein the apparatus further comprises:
the charging device comprising one or more batteries and wireless charging circuitry.

15. The method of claim 10, wherein the opening of the phone pocket is closed by a zipper, the zipper extends transversely.

16. The method of claim 9, wherein the bag body has a main compartment, the main compartment divided into two by a dividing panel, the main compartment has a longitudinal opening at a top of the bag body secured by a main fastener.
